(19) United States
(12) Patent Application Publication
(10) Pub. No.: US 2014/0096167 A1
(43) Pub. Date: Apr. 3, 2014

(54) VIDEO REACTION GROUP MESSAGING WITH GROUP VIEWING

(71) Applicant: Vringo Labs, Inc., New York, NY (US)

(72) Inventors: Andrew K. LANG, New York, NY (US); Steven SPENCER, New York, NY (US)

(73) Assignee: Vringo Labs, Inc., New York, NY (US)

(21) Appl. No.: 14/018,157

(22) Filed: Sep. 4, 2013

Related U.S. Application Data
(60) Provisional application No. 61/707,504, filed on Sep. 28, 2012.

(51) Int. Cl. H04N 21/4788

(52) U.S. Cl. CPC H04N 21/4788
USPC 725/91

(57) ABSTRACT

A system and method to create integrated reactions video that include one or more reactions presented in a synchronized manner with the original message video. The reaction and the original video are presented as complete package. In this manner, there is no need to search for and watch reaction videos individually. Additionally, because the original video is watched in synch with the reaction video, it is evident what portions of the original video are creating each specific reaction.

### CROSS-REFERENCE TO RELATED APPLICATIONS

This is a non-provisional application of U.S. Provisional Application No. 61/696,388, filed on Sep. 4, 2012, and U.S. Provisional Application No. 61/707,504, filed on Sep. 28, 2012, the entirety of both incorporated herein by reference.

### FIELD OF THE INVENTION

The present application relates to social media video messaging and more particularly to the manner in which reaction videos are presented.

### BACKGROUND

Reaction videos are a phenomena on social video sites such as YouTube. A typical reaction video involves recording an individual or a group watching a YouTube video or other video. The reaction video without the original video is then posted on YouTube or another video site. The present state of the art with reaction videos requires an individual to post their own reaction and to search and view the reactions of others, viewing them one at a time. Additionally, the present state of the art does not easily limit a reaction group to a small private group such as a select group of friends, family, or the like.

Existing video products such as mobile MMS messaging permit sharing of a video message with a single person or a group. A recorded video response is a single message that can be sent back to the originator of the original video, posted on a social media site, sent to a group, or the like. The response is recorded as a separate session from the original watching of the video.

Existing Video messaging platforms such as Skype, Oovoo and Fring permit one-to-one, one-to-many, and many-to-many live video calls. These messaging platforms are focused on real-time video communication.

### SUMMARY OF THE INVENTION

According to one embodiment of the invention, an original video and the automatic combining of reaction videos, with the original video is enabled in a simple format. One embodiment of the invention permits the original and reaction videos to be shared privately within a selected group or public.

According to one embodiment of the invention, a user sends a video to one or more friends. Each recipient of the video simultaneously watches the video and records their reaction to the video. Each of the reaction videos is incorporated with the original video message in a single video stream for viewing by the originator and participants. The video message with reactions can be posted to social media sites and shared publicly. The video message and reactions can originate and/or be viewed either through a mobile device (SmartPhone), Tablet (i.e. iPad), or personal computer.

The Smartphone and Tablet embodiments will include a Smartphone Application (i.e. Android and iPhone). The computer embodiment would include a social media application (i.e. Facebook).

The reaction videos are presented with the original video so that both the original video and one or more of the reaction videos are viewed simultaneously. In one embodiment, the viewer selects which of the one or more of the original videos and reaction videos are viewed with an audio track.

Normally in a video call, the person being viewed looks odd when because of the lack of an appearance of “eye contact” due to the camera being to the side of the video output device being viewed. The present invention, improves the experience if the camera is arranged on a side of the output device, perhaps even more than is usual if detachable from the display, provided that when the videos are stitched together, it is done so that the reactor appears to have their gaze shifted towards the original video being reacted to. This would require tagging the reaction video to note which way the reactor has their gaze shifted so it is stitched together properly, and may require some guidance from the application to the reactor to coordinate how the camera and output display are separated. In other words, the reaction video would be tagged “looking left”, “looking right”, “looking up”, “looking down”, and the like.

In one embodiment of the invention, video display eyewear functions as the local devices. A camera can either be attached to the eyewear via a camera stalk so that the camera can get a side shot of the user face, or be separated and recording the reacting user. Video processing may also be used to automatically remove the eyewear from the reactor's face in the reaction video.

One embodiment of the invention is used as a part of an interactive game, a training program, psychological testing, marketing focus groups, and product evaluations.

One embodiment of the invention is a peer-to-peer system in which distribution does not occur through a server when the video is shared privately.

One embodiment of the invention provides for take-down notices for videos that are improperly being shared, such as improperly shared copyrighted videos.

One embodiment of the invention enhances sharing videos through a phone experience by providing a group video sharing experience. Group messages are provided as well as shared multiresponse messages.

One embodiment of the invention provides for selecting and sharing videos and the delivery of targeted advertising.

### BRIEF DESCRIPTION OF THE FIGURES

FIG. 1 is a screenshot of the application after receiving a message;

FIG. 2 is screenshot of the application showing a video;

FIG. 3 is screenshot of the application preparing to create a video;

FIG. 4 is screenshot of the application for creating and uploading a video;

FIG. 5 is screenshot of the application recording a video;

FIG. 6 is screenshot of the application completing the recording;

FIG. 7 is screenshot of the application selecting a video thumbnail;

FIG. 8 is screenshot of the application sending a message;

FIG. 9 is screenshot of the application providing a notification;

FIG. 10 is screenshot of the application creating a video response

FIG. 11 is screenshot of the application selecting a response thumbnail and sending the response;

FIG. 12 is screenshot of an inbox of the application;

FIG. 13 is screenshot of the application showing a video and response videos;

FIG. 14 is schematic depiction of a user interface for the application;

FIG. 15 is a flowchart for adding the application;

FIG. 16 is a flowchart for viewing and responding to a video;

FIG. 17 is a flowchart for creating a video; and

FIG. 18 is a flowchart for using the application.

### DETAILED DESCRIPTION

The present invention presents a new style of video group messaging. One embodiment of the invention provides for simultaneous recording of a users reaction while watching a message video. This simultaneous recording provides a record of users initial reaction to the video. Existing reaction videos are planned “events” in front of a computer, and provide for no way to synchronize the reaction video with the original video. According to one embodiment of the invention, the original video cannot be viewed without the reaction video being recorded so that the initial reaction to the video is captured. Further, the reaction video is synchronized with the original video for simultaneous playback of both videos. Synchronization meta-data is kept so reaction videos and original video can be stitched together properly.

This invention seamlessly interacts with mobile, tablet, and Web based social media. The interaction takes place over a cellular network, WAN, LAN, WLAN, and the like. While existing real-time video calling services are configured for multiplatform operation, there are no video reaction applications that operate in the disclosed manner.

This invention creates an integrated reactions video that includes one or more reactions presented in a synchronized manner with the original message video. The reaction and the original video are presented as complete package. In this manner, there is no need to search for and watch reaction videos individually. Additionally, because the original video is watched in synch with the reaction video, it is evident what portions of the original video are creating each specific reaction.

There is a practical limit to the number of reaction videos that can be viewed simultaneously with the original video. This can be overcome by either having multiple videos, each with a fixed number of reactions, or by creating a video application that permits scrolling through a large number of reactions to select the ones that will be viewed with the original video. In one embodiment, reaction videos are tiled around the original video. In one embodiment, the reaction videos are presented in list or tabular form proximate to the original video. In one embodiment, a viewer can select which reaction video to playback with the original video and which of the videos will have their audio track played.

Preferred embodiments have client side software for mobile and Web base applications that operate in conjunction with server-side functions. The server side functions typically include video functions and social sharing functions.

The application is preferably configured to operate on one or more platform. For example, for a mobile Smartphone, the application resides on the Smartphone and is configured to send the original video, record reactions, and viewing reaction videos presented simultaneously with the original video. A similar application functions on a tablet device.

To interact with social media, a Facebook Application or other social media site application is provided. The Facebook application provides for sending original video, recording reactions, and viewing the original video with the reaction videos.

In one embodiment, a Web Based Application resides on a Web site. The Web base application is preferably a Flash based application for sending original video, recording reactions and viewing the original video with the reaction videos. A kiosk based application resides within a Kiosk and interacts either with other Kiosk or other Web connected devices (Smartphones, tablets, computers, etc). It should be noted that a message could originate on any other the named platforms and interact with users on any other names platform.

In one embodiment, each reaction video is appended in a synchronized manner to the original video so that the reaction video and the original video are viewed synchronously. In one embodiment, this combining of the video and the reaction video occurs locally at the reaction viewer's device. In one embodiment, an end user stitches together the original video and selected reaction videos. In one embodiment, the creator or administrator of the original video selects the response videos that are displayed with the original video. The original video creator or administrator also determines if the original video and the reaction video are to remain private within a designated group or if they can be freely distributed. In one embodiment, the creator of the reaction video can determine if the specific reaction video is to be public or private.

In one embodiment, drop-down menus or radio buttons are provided that allow each user the opportunity to designate public or private viewing rights. Additionally, a time limit can be set for each video so that after a designated time, number of views, or the like, the video can no longer be viewed. In other words, receivers decide and specify, via checkbox, whether they give permission to post combined reaction video to social media or whether they want the reaction kept private.

In a preferred embodiment, the end user can mute individual reaction videos. Alternatively, the video creator or administrator selects which videos are presented with audio. In one embodiment, if the video (original and reactions) is distributed as a single stitched together video, which requires that multiple audio channels are maintained as separate audio channels for each reaction.

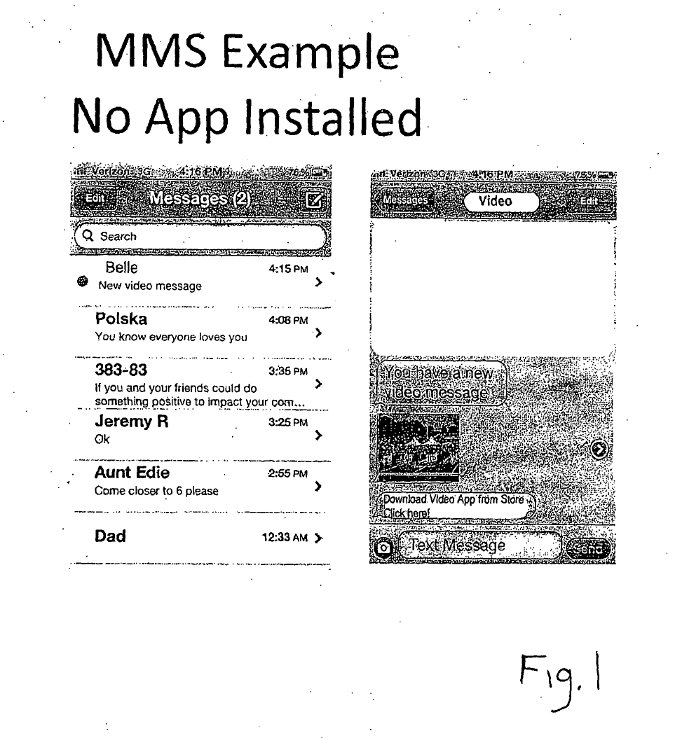

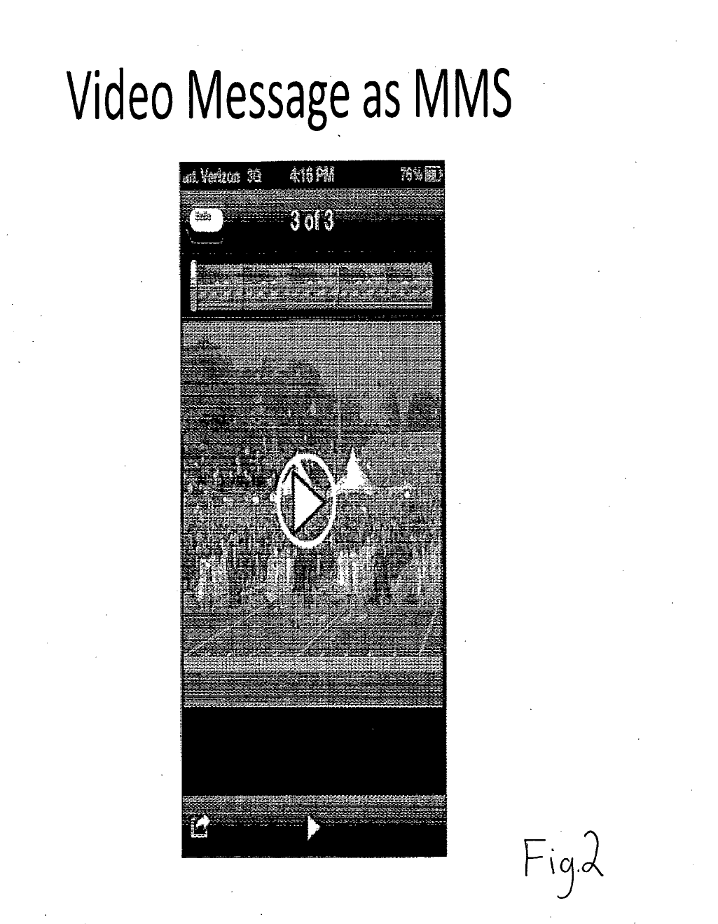

In one embodiment, a user uploads a video. The uploader selects a public upload or selects specific users to view the video. The specific users receive a notification that there is a video available for their viewing. The specific user is notified of new video and the video reaction application. If the user does not have the application available or installed, a prompt first ensures that the application is downloaded and installed. For example, as shown in FIG. 1, the intended recipient receives an MMS message that they have received a video from a friend. The recipient is then instructed to install the application that allows them to watch an MMS version of the video as shown in FIG. 2. The video is then streamed or pre-buffered with a notification to the user when the video is fully downloaded and ready for viewing. In this manner, the video is not delayed due to buffering delays so the reaction is not affected in any way. Recent videos and reactions are maintained local to device, cached. Preferably, the videos are automatically off-loaded to cloud storage when they have not been viewed or sent for a specified period to save on space in local device. In one embodiment, the original creator or administrator can include a video reaction that can be a video narration or an initial reaction.

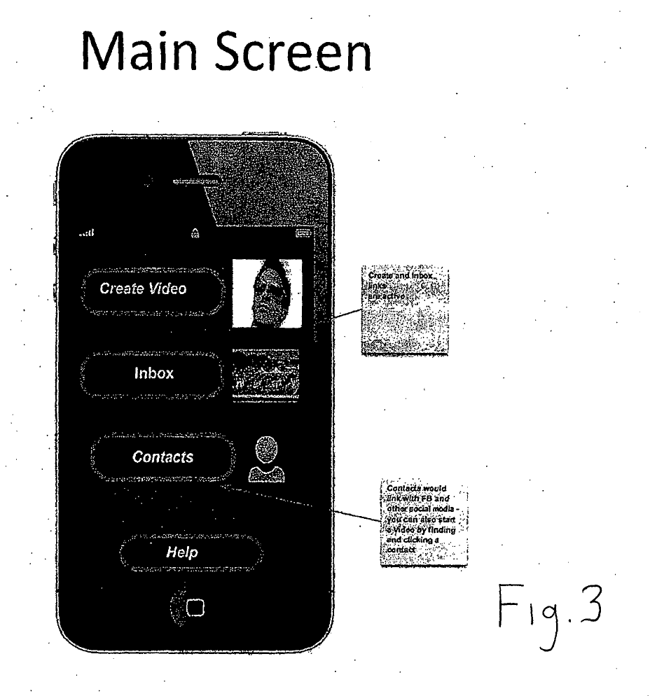

A main screen of the application is shown in FIG. 3. The main screen presents a user with options to create a video, review their inbox to view responses to shared videos or view new videos, access and manage their contacts, access a help menu, or other administration functions as required.

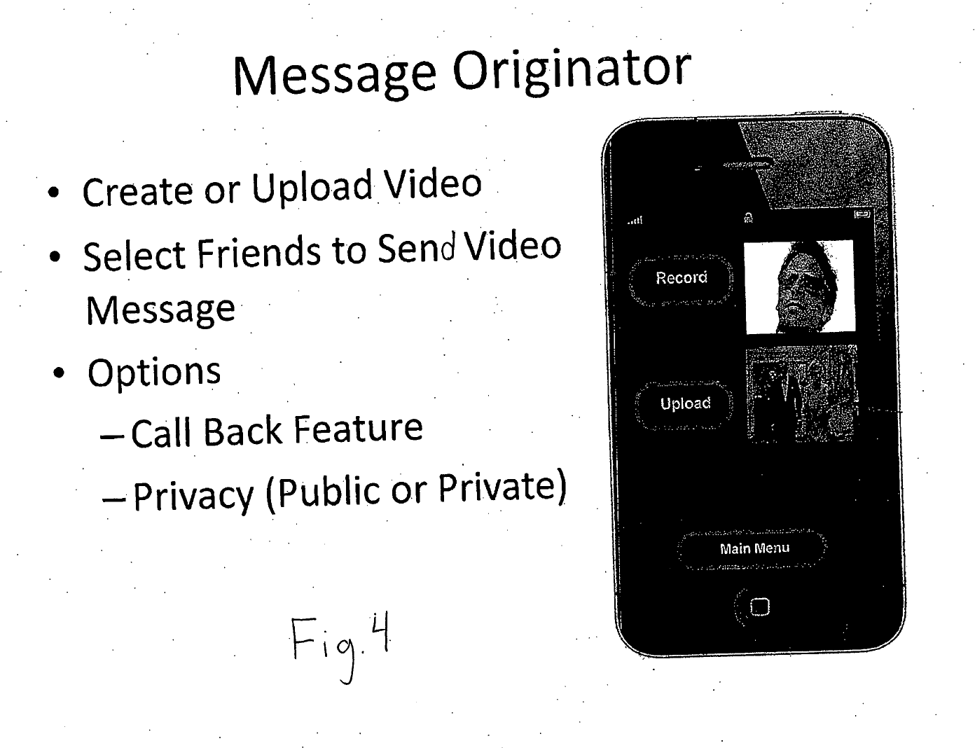

In one embodiment, once a user records a reaction video, the user can rewatch the original video with the reaction videos multiple times, without creating a new reaction video. As a message originator, a user can record and upload a video as shown in FIG. 4. The message originator has the option to create and upload videos and select frients that will receive the video. The originator can also select if the recipient can call the originator and designate the video as public or private. In one embodiment, the user can create a reaction video to one of the other reaction videos. In one embodiment, one or more of the original video poster and each of the reaction video creators are notified each time a new reaction video is created.

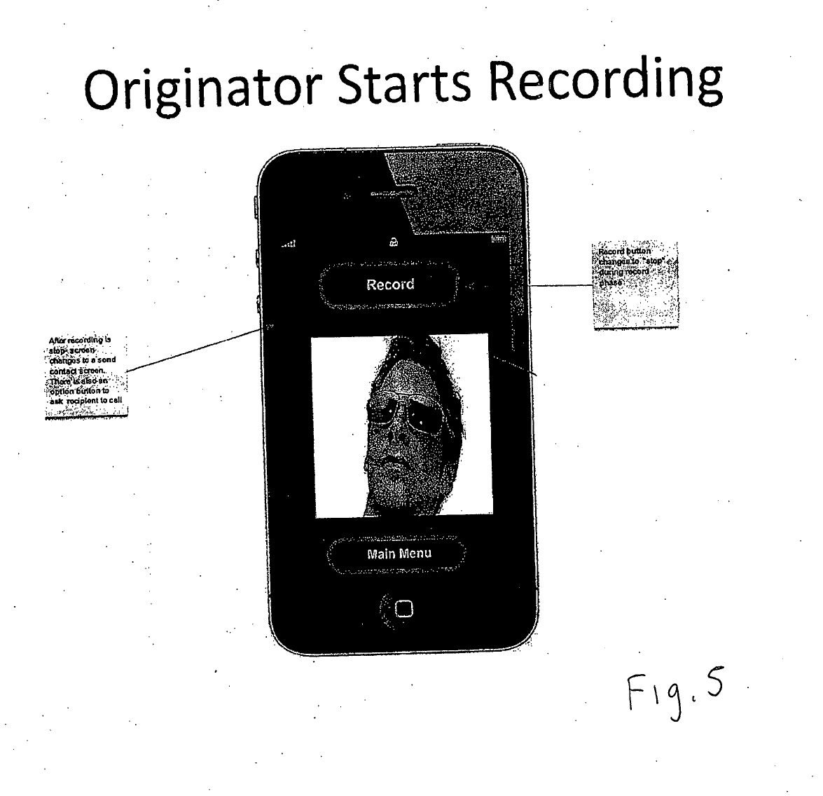

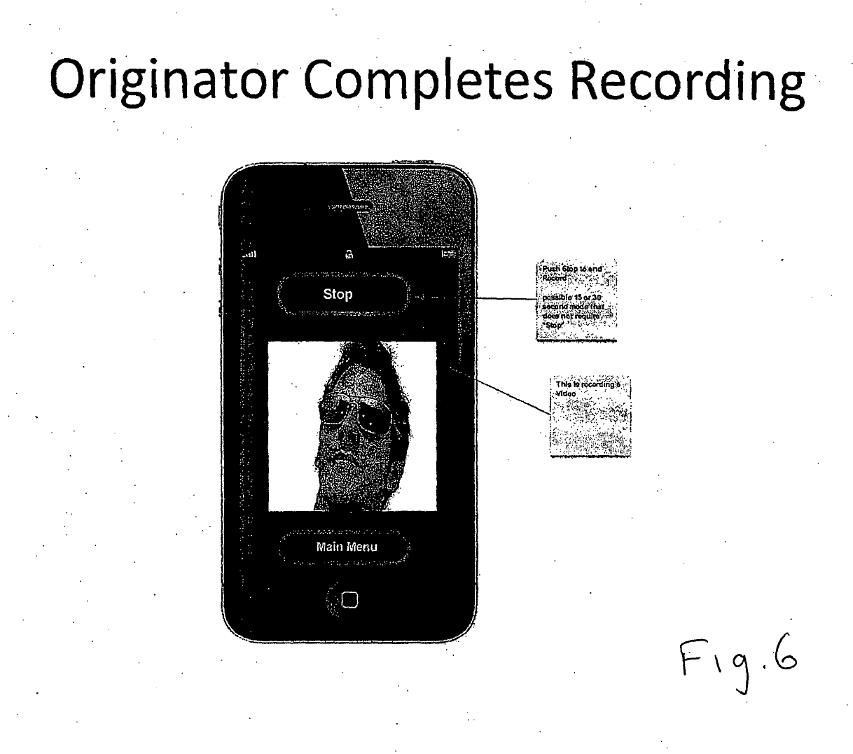

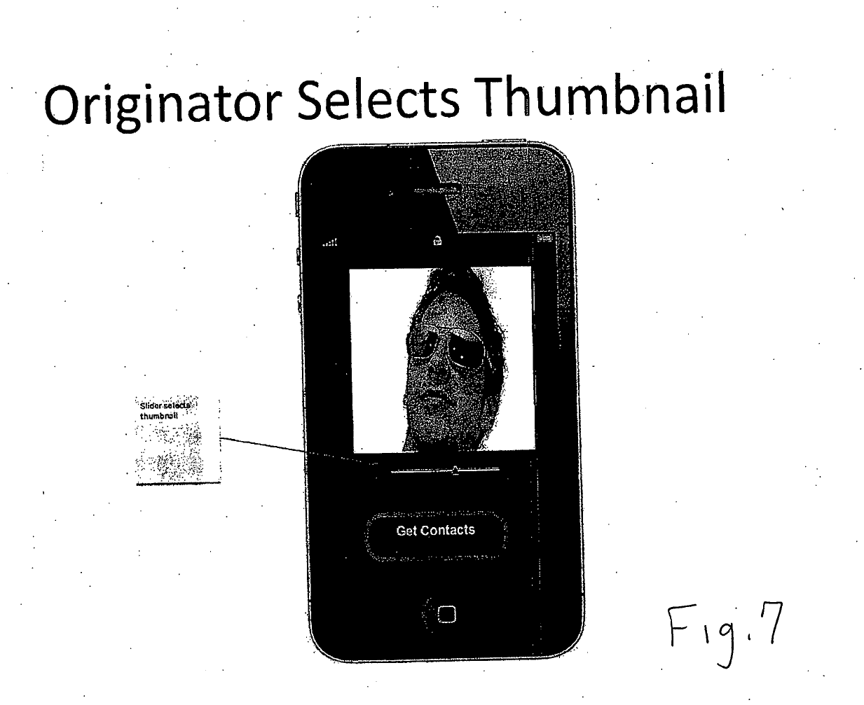

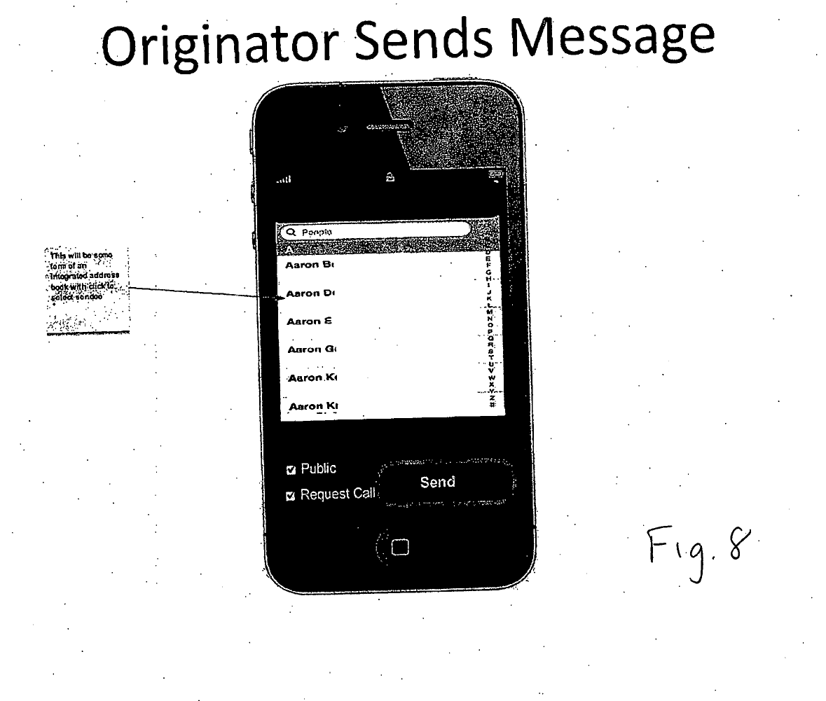

To create a video, the originator selects a “record” button as shown in FIG. 5. After recording begins, the “record” button changes to a “stop” button as shown in FIG. 6. The originator can select a thumbnail to send with the video announcement as shown in FIG. 7. Once the thumbnail is selected the user can select who should receive the video from a list of contacts and send the video as shown in FIG. 8.

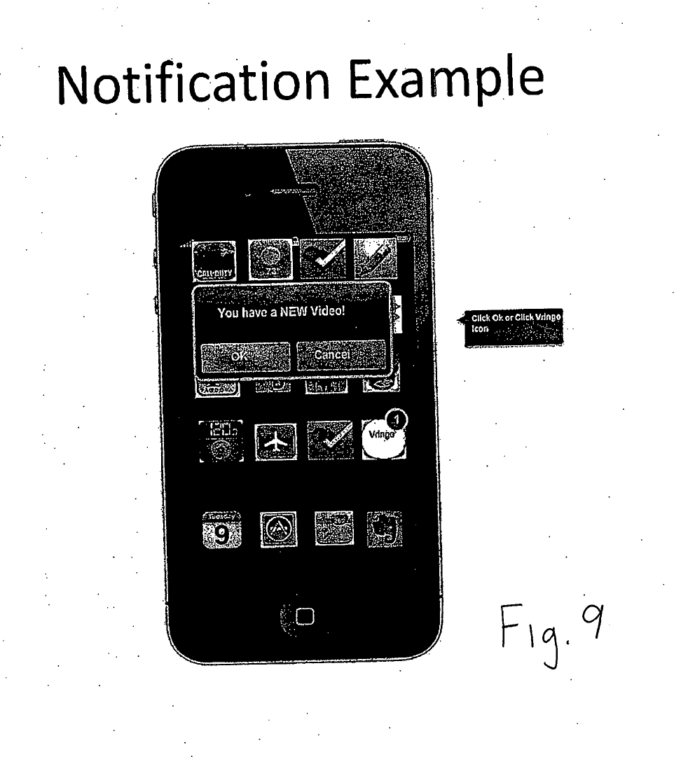

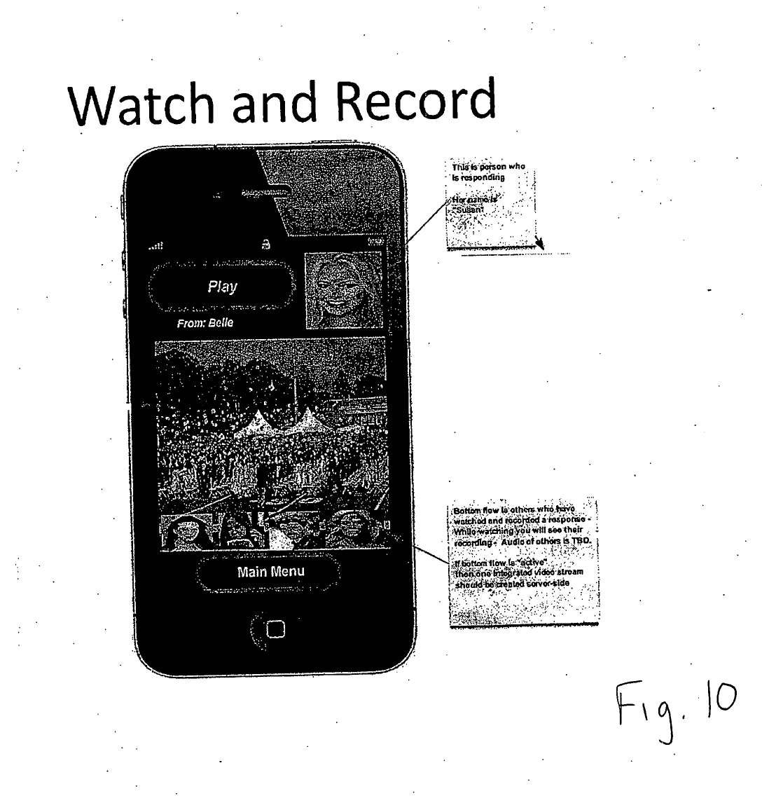

As shown in FIG. 9, when a recipient receives a new video a notification pop-up message is generated. In one embodiment, the recipient can modify the notification so that no pop-up is generated or another style of notification is provided such as a ringtone, a flash, a vibration, or the like. Once the recipient opens the video, the recipient can watch the video while simultaneously recording a response video. A sample playback and record screen is shown in FIG. 10. As shown, the playback screen includes a button to begin playing the video. The play button preferably begins recording the recipient as playback begins. Subsequent playbacks do not record the recipient. However, if another viewer is to be recorded a new response video can be included with a tag to identify the new viewer. The screen identifies the originator and the recipient. In one embodiment, the video includes response videos from other recipients. In one embodiment, a user can customize the playback to include or exclude video responses on the initial playback and other playbacks.

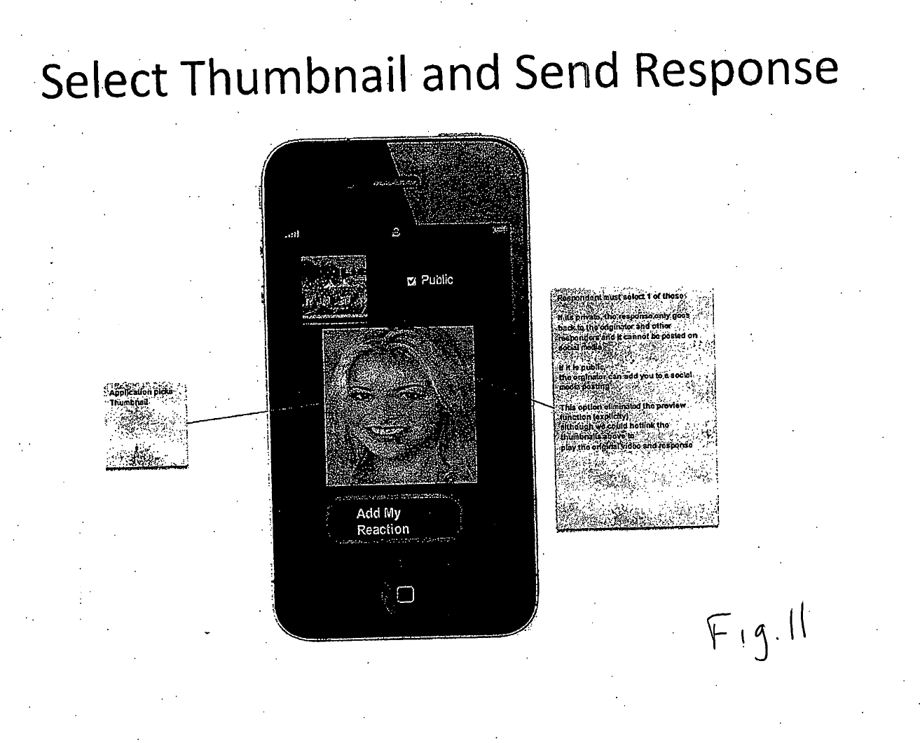

Once a recipient records a response video, the recipient can select a thumbnail and add their response video. This is done using the screen shown in FIG. 11. If the originator allowed for callback, the recipient is given an option to call the originator at this point.

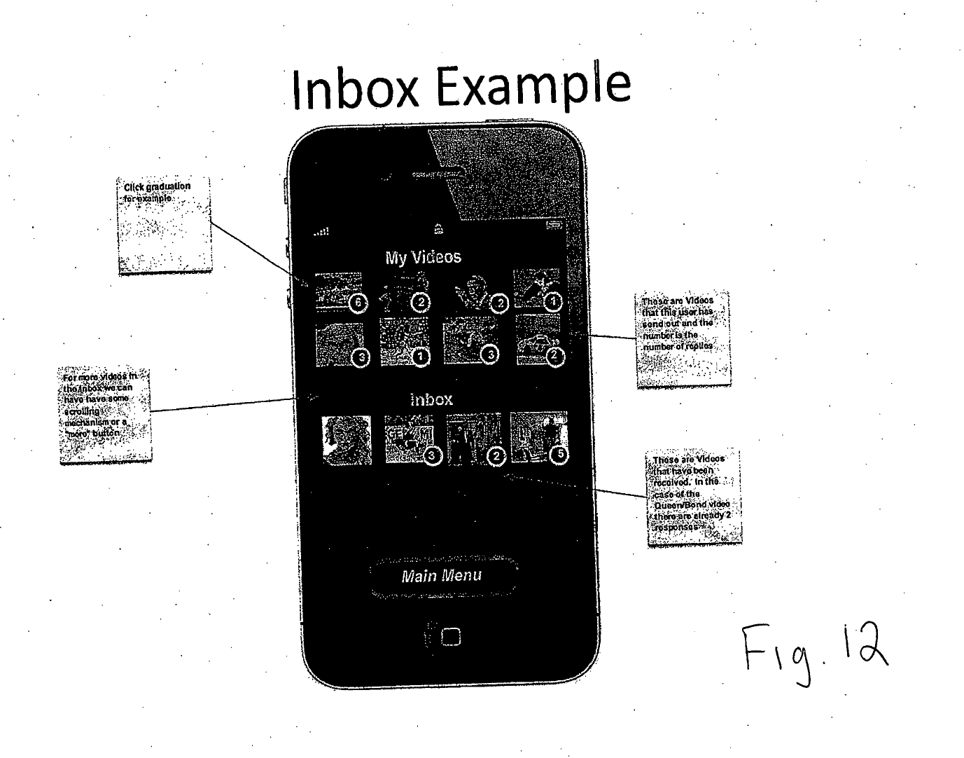

FIG. 12 depicts a user's inbox. In one embodiment, the videos are divided into two separate groups, one group of videos that the user received and another group that the user created. Each video has a number indicating the number of response videos. Alternatively, the videos an be color coded to indicate if they were received by the user of or created by the user. any video can be selected and viewed, with or without the response videos.

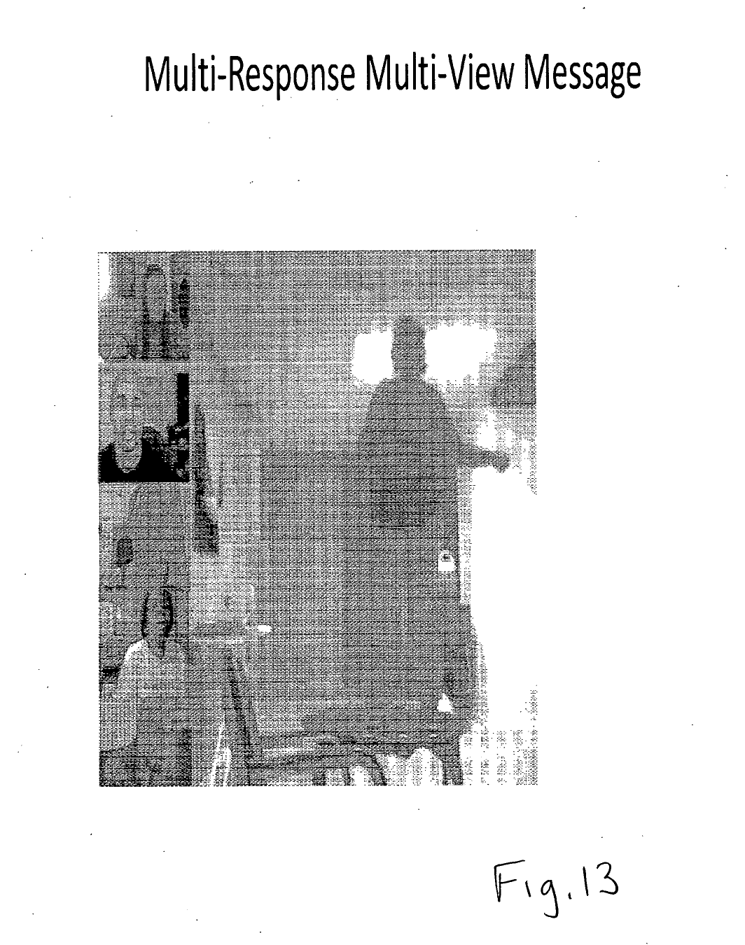

In one embodiment, the originator sends a preexisting video or a link to a preexisting video. This video can be streamed or downloaded. As with the originator created videos, response videos can be displays in synchronicity with the original video as shown in FIG. 13.

While users can be prevented from fast forwarding or skipping parts of the original video, if a user skips or fast forwards portions of the video the reaction video is marked to designate such an action. For example, the reaction video can include a text label such as “no reaction, skipped” or a symbol “>>” overlaid across the static image of the user's face to denote that no reaction is present. In one embodiment, the user has full control over the video, including playback functions such as pause, rewind, and fast forward. The pause function permits a viewer to pause the original video and react. In other words, the original video is paused and the reaction video is recorded. For playback of multiple reaction videos simultaneously, all videos are paused with the original video to maintain playback synchronization. Alternatively, the additional video in the reaction video is truncated so that no pausing is required during playback. A label will appear to notify a viewer that additional material is skipped so it can be viewed, if desired. This way, if they need to comment more extensively on what just happened, or if the track becomes too busy and the reactor wants all the other parts to stop while they react, then can do this. A standard pause symbol would flash on the main video and prior reactors while the present reactor reacts.

In one embodiment, the video creator or administrator or the user that creates a reaction video can request that a call is initiated at the end of the video. In one embodiment, this call is placed automatically to connect the video creator or administrator with the reaction video creator.

In one embodiment, an audio reaction without a corresponding video can be created. In this embodiment, the reaction creator can designate if a video is to be created. In one embodiment, the original creator can designate if a response must include a video. For audio only reactions, the audio only mode is available if the reaction creator does not want their video recorded or if they have a microphone but no camera. In one embodiment, a user can upload a static image to be seen while the audio track is played.

Teaser video snippets can be sent via MMS to users prior to them having the reaction application to inform them to download the app and watch the full video. Preferably, download and install instructions are provided with the original video reaction invitation.

If there are a large number of users reacting to a video, but only a limited amount of space on screen to keep them next to original video, the reaction videos can be swapped in and out based on how active they are on video, how loud they are in audio, how recent their reaction is relative to the other reactions, and/or stated preferences for the various users reacting stated by the user watching the reaction. In one embodiment, viewers can vote on videos and highest rated videos are displayed closest to the original video.

In one embodiment, multiple viewers view a video when they are near to each other, but each using a personal device. Alternatively, the original video can be viewed on a movie screen with the reaction videos being recorded on personal devices. Just observing how connected people are to their devices, even when they are very near to the others to which they want to react, we may have here how people consume entertainment “together” going forward. People in the same building may each have their own preferred device and decide to watch a video “together” at roughly the same times, pause, or fast forward as desired, and the others watching the video “together” will each have their reactions recorded and synced across devices so that if you start off watching before other people, those people will still have the benefit of seeing your reaction. In this manner, as discussed above, if one of the viewers pauses the video to perform another function, such as read an email, and the others “catch up” to you and pass the user, the user will begin to see their reactions alongside the main video when the original video is restarted. Thus, people do not have to wait while others are say, getting a popcorn refill, and it will seem obsolete to do so. In one embodiment, as reaction videos are generated, they are automatically added and viewed with the original video. In this manner, a user could start viewing only the original video and by the end of the video, multiple reaction videos are also displayed.

In one embodiment, the application is distributed free of charge. The free version of the application has limited functions. A premium version is available for a fee. The pay version provides more user functions, availability of more reaction videos, enhanced searching, and the like. In one embodiment, the free version includes video and banner ads or sponsored videos. The pay version or premium version provides full functionality that may include video editing, elimination of standard ads, and allows for In-app credit purchases. Preferably, the sponsored videos are present in each version. Other features discussed above can be present in either version or can be added on a fee basis.

The application is configured to be run on a microprocessor and stores on a nontransitory computer readable medium. Preferably, the application is stored in a memory and run.

In one example of a system and method using the present invention, a user searches for a video that meets the user's viewing criteria. The viewing criteria can include one or more of a new episode of a show, a show with a specific actor, a show on a specific topic, a specific movie, a favorite show or movie, and the like.

In one embodiment, a user may notice a new episode of a favorite show or a new video on demand is released and will be broadcast via medium M. The user initiates an electronic invitation to watch the show or movie to his family, friends, and/or like-minded online cohorts at a specific time, 9 p.m., the broadcast time for the show or movie. It should be noted that due to the synchronizing function with this invention people do not have to all show up exactly at the same time. In other words, viewers access an online link or log onto a web site at a time to watch the show or movie and have their reactions recoded as they view. All of the invited guests do not have to access the show or movie simultaneously.

The invitation to watch is added to each member's respective calendar. If the user cannot watch at 9 p.m., close to the designated time, each invitee can watch the show or movie at any time later and it will still seem like they are all watching it with the group, since their facial reactions and auditory reactions are recorded simultaneously. Further, each user can still see and react to other viewer's reactions.

One or more of the group can still watch the video together in a traditional living room couch setting. In this case, an offset camera records their reactions and automatically isolating either their faces or their whole bodies via video processing. In one embodiment, the whole body video processing is accomplished with a gaming console and sensor such as an xbox360 and Kinect input device. Audio for the couch-sitters is recorded together as one channel, or their audio can each be isolated using two microphones and standard audio signal processing. Preferably, the microphones are not on the viewers, the microphones use time offset triangulation for isolation processing and recorded on multiple channels.

Each member of the group can watch the video using their preferred device including one or more of a TV, computer display, Facebook app, smartphone, iPad, tablet computer, tablet device, automobile infotainment canter, virtual display glasses, and the like, in their preferred location (in bed, backseat of car, living room, kitchen, etc.) at their preferred time (simultaneously or another chosen time, as a group, individually, or time-delayed and synchronized). The closer in time they are able to watch it together, the more each of them can see others' reactions simultaneously and interact with each other bidirectionally. In this “leading wave of viewers” mode, the reaction videos are very slightly delayed from the video in the same way a group video conference call has slight delays. Other viewers who are “behind” in time will see perfectly synchronized video with reaction videos.

Viewers can independently choose to pause or fast-forward their video as desired. In one embodiment, one or more of these playback functions is disabled. If a viewer pauses the main video to provide a reaction video comment, the other viewers can watch the comment while the main video is paused, or they can hit a “skip” button to skip over the comment and continue the main video.

In one embodiment, each viewer has control over who they want to watch reactions with their main video. Similarly, if they do not like someone's reactions, they can replace them with someone else's reaction video. If a viewer's reaction is too loud or distracting, the viewer can mute that specific reactor or turn down each reactor's audio independently.

The reaction videos can be arranged in an array along the edges of the primary display device (such as in the big living room TV scenario) or they can be output to auxiliary devices (since they are proliferating so rapidly). By using auxiliary devices, users can view reactions to the video on, for example a tablet device with one earbud to hear their audio, while watching the main video on the primary living room TV along with another user in the room. By putting the reaction videos on separate auxiliary devices, users that do not want to view reaction videos do not have to. Each family member can be on the same couch, watching the same video together, while independently choosing whom else beyond their family they want to share reactions with.

In one embodiment of the invention, the goal of the software managing the experience is to bring as many of the viewers into near-simultaneous viewing as possible so more reactions can be shared with more of the group, a virtual “viewing flash mob”. The system may assign advertising credits to each viewer to defray the cost of viewing. When a viewer gets slightly ahead of the others in the group (because of pausing, fast-forwarding, etc.) the experience-managing software can show an advertisement, or preferably a personalized advertisement to that viewer to bring them back into realtime synchronization with the next set of people in their group. Alternatively, the personalized advertisement is mixed with other entertainment such as a low-cognitive game to keep the viewer fully engaged. By combining a “group video experience” with a “personalized advertising capability” a strong human bonding experience is achieved while simultaneously increasing ad revenue through personalization, which is not possible via the traditional group viewing experience on the sofa together.

The present example combines the benefits of time shifting with the benefits of place shifting and the additional benefits of a video conferencing system to achieve a group experience via video. The present method integrates people so that they watch media together, with technology as the intermediary, as opposed to more isolated experiences that result in fragmentation.

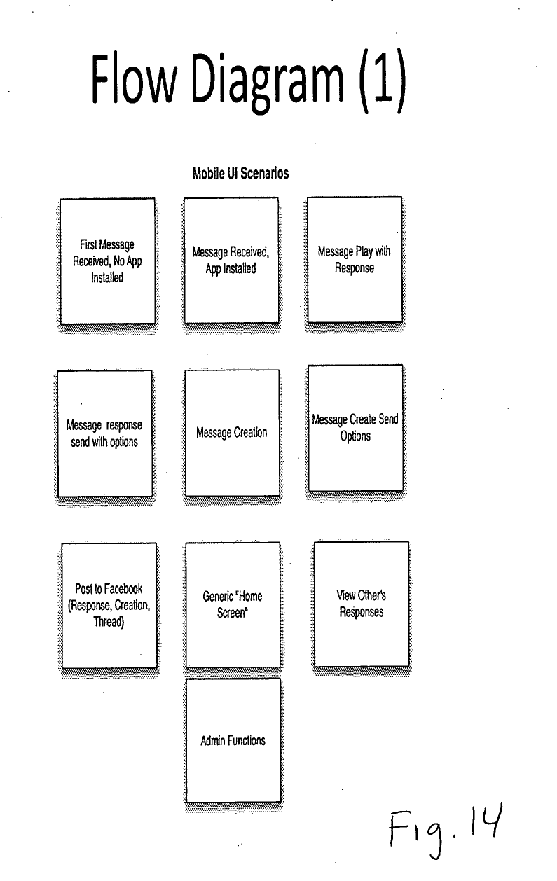

FIG. 14 is a flow diagram presenting the various options for interacting with the application. The options include receiving a message without the application installed, receiving a message without the application installed, playing the message with a response, options for sending a message response, message creation, message create send options, posting options, home screen, view other's responses, and administration functions. In one embodiment, each option is presented as a radio button that accesses the named functions. Once accessed, the examples above apply to the various functions.

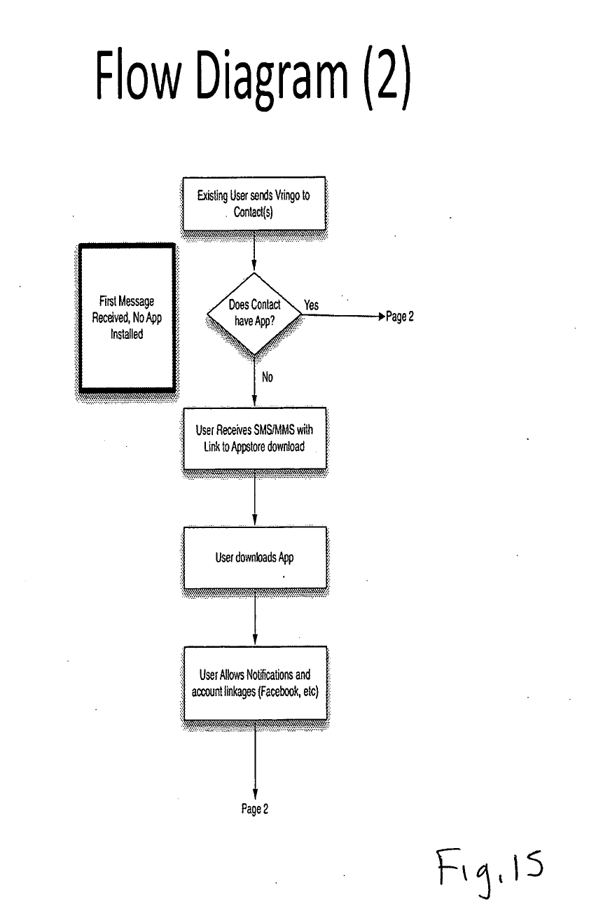

FIG. 15 is a flowchart depicting the steps when a user adds a contact to the application to send a video to a contact that does not have the application installed. Alternatively the user provides their contacts to a central server or hub. The central server checks the contacts to see if the contacts are subscribers or if they already have the application downloaded. When a contact receives a message and does not have the application a notification message is returned to the central server or hub. If a contacts does not have the application, the contact receives an SMS/MMS with a link to an application store to download the application. The contact then downloads the application and allows links to various email and social media accounts. The new user's contacts may be processed in a similar manner to expand the network.

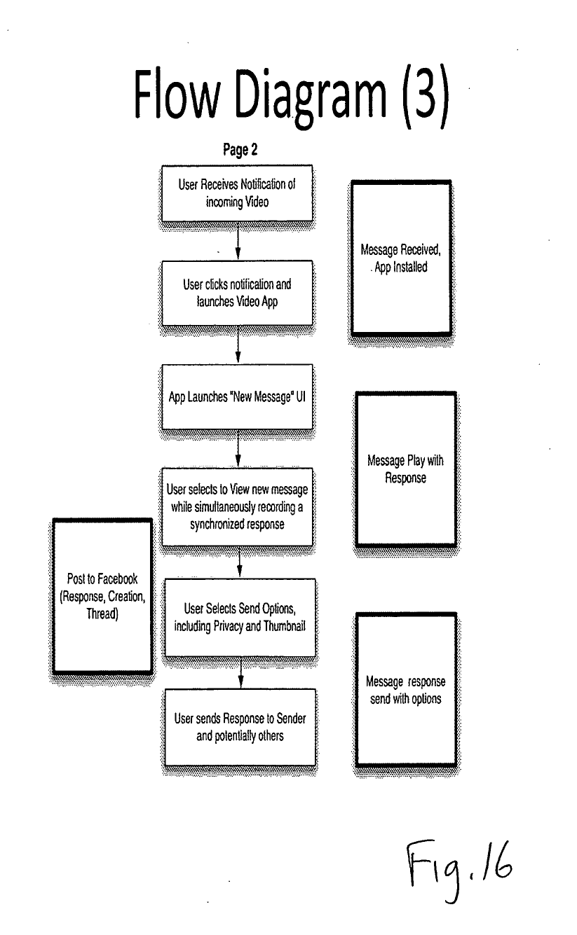

FIG. 16 is a flowchart depicting the steps when a user adds a contact to send a video to a contact that has the application installed. The recipient receives notification of the incoming video. The user clicks the notification and launches the video application. The application launches a new message user interface. The user then views the message while simultaneously recording a synchronized response video. The user then selects the send option and sends the response to the original sender and potentially others.

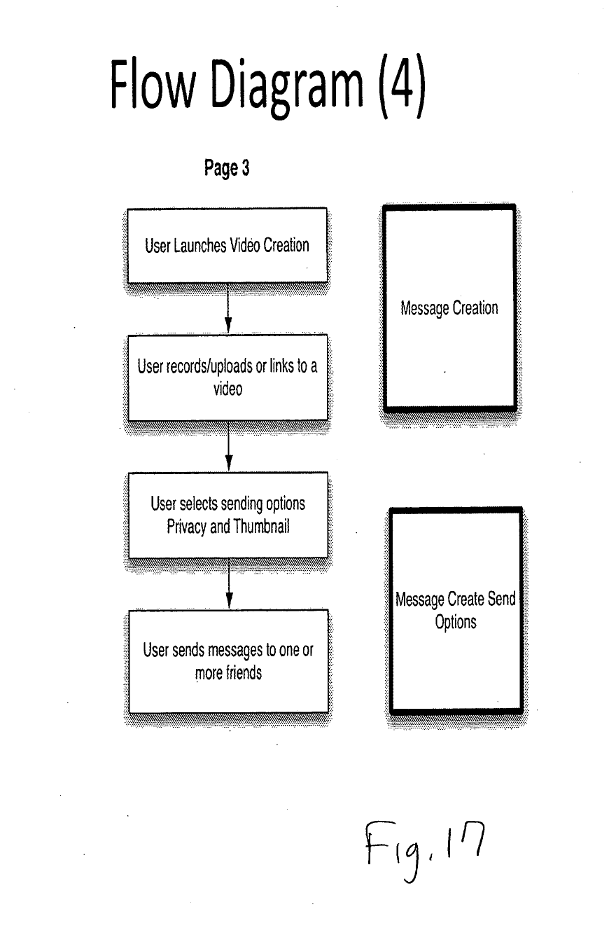

FIG. 17 is a flowchart depicting the steps of creating a video. The user (sender) launches the video creation portion of the application. The user then records or links to a video. The sending options are selected including privacy settings and a thumbnail. The video is then sent to one or more contacts (friends).

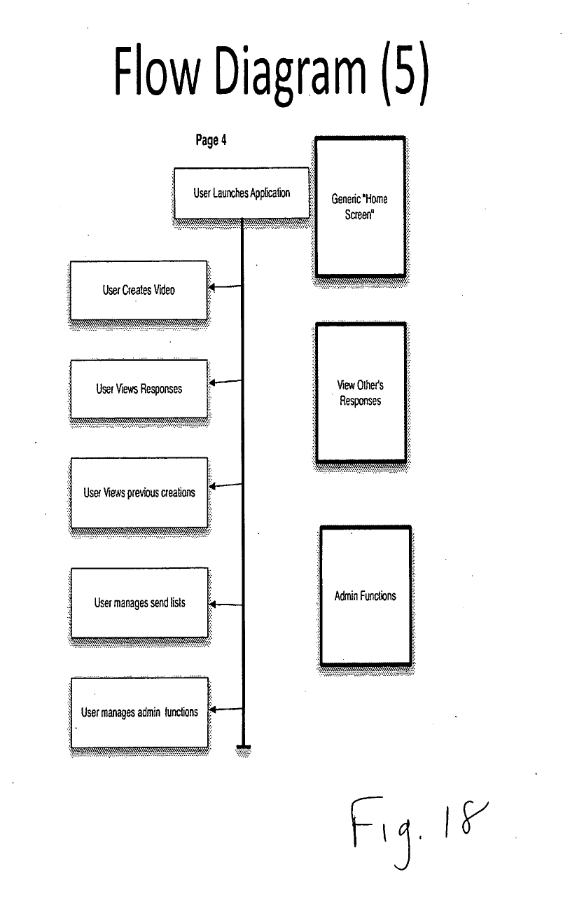

FIG. 18 is a flowchart depicting the options a user has once the application is launched. From the home screen the user can create a video, view responses, view previous creations, manage contacts or sent lists, and access administration functions.

The present invention may be described herein in terms of functional block components, code listings, optional selections, and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, or the like, with the various algorithms being implemented with any combination of data structures, objects, processes, routines or other programming elements.

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, and application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

One skilled in the art will appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

In the specification, the term “media” means any medium that can record data therein. The term “media” includes, for instance, a disk shaped media for such as CD-ROM (compact disc-read only memory), magneto optical disc or MO, digital video disc-read only memory or DVD-ROM, digital video disc-random access memory or DVD-RAM, a floppy disc, a memory chip such as random access memory or RAM, read only memory or ROM, erasable programmable read only memory or E-PROM, electrical erasable programmable read only memory or EE-PROM, a rewriteable card-type read only memory such as a smart card, a magnetic tape, a hard disc, and any other suitable means for storing a program therein.

A recording media storing a program for accomplishing the above mentioned apparatus maybe accomplished by programming functions of the above mentioned apparatuses with a programming language readable by a computer or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer-processing device, any suitable device for performing computations in accordance with a computer program may be used. Examples of such devices include a personal computer, a laptop computer, a microprocessor, a programmable logic device, or an application specific integrated circuit.

While this invention has been described by reference to a preferred embodiment, it should be understood that numerous changes could be made within the spirit and scope of the inventive concepts described. Accordingly, it is intended that the invention not be limited to the disclosed embodiment, but that it have the full scope permitted by the language of the following claims.

We claim:

1. A method for creating video reactions, comprising:
providing an original video to at least one user;
playing the video;
recording a reaction video;
receiving a video reaction from the user; and
synchronizing the original video and the reaction video so that the original video and the video reaction are viewable simultaneously.

2. The method of claim 1, wherein the reaction video is recorded automatically as the video is played.

3. The method of claim 2, wherein the reaction video is recorded only a first time the video is played.

4. The method of claim 1, wherein a plurality of reaction videos are recorded.

5. The method of claim 4, wherein the plurality of reaction videos are displayed simultaneously and in synchronization with the video.

6. The method of claim 1, further comprising:
one of recording the original video and providing a link to a video as the original video; and
selecting a thumbnail to identify the original video.

7. The method of claim 1, further comprising selecting a privacy setting for the original video.

8. The method of claim 1, wherein targeted advertising is provided with at least one of the original video and the reaction video.

9. A method for creating a group video reaction, comprising:
sending an invitation to at least one user to view a scheduled video;
playing the video;
recording a reaction video for each respective viewer of the scheduled video;
receiving a video reaction from each respective viewer of the scheduled video; and
synchronizing the original video and the reaction videos so that the scheduled video and the video reactions are viewable simultaneously.

10. A system for creating video reactions, comprising:
a first device configured to provide an original video to at least one user;
a second device configured to receive a video reaction from the user;
a third device configured to synchronize the original video and the video reaction so that the original video and the video reaction are viewable simultaneously.

11. The system of claim 11, wherein the third device is a portion of at least one of the first device and the second device.
